(19) United States
(12) Patent Application Publication
(10) Pub. No.: US 2021/0156140 A1
(43) Pub. Date: May 27, 2021

(54) METHOD OF MANUFACTURING FLEXIBLE INSULATING ELEMENT WITH RECYCLED EXPANDED POLYSTYRENE FOAM

(71) Applicant: Taylor Wilhelm Hager, Geismar, LA (US)

(72) Inventor: Taylor Wilhelm Hager, Geismar, LA (US)

(21) Appl. No.: 16/695,857

(22) Filed: Nov. 26, 2019

(51) Int. Cl. E04B 1/76; E04C 2/296; E04C 2/30; C08J 9/228

(52) U.S. Cl. CPC E04B 1/7654; E04C 2/296; E04C 2/30; E04B 2001/746; C08J 2325/06; C08J 2205/06; C08J 9/228

(57) ABSTRACT

A method of recycling expanded polystyrene foam into flexible insulation elements that are made from 100% recycled material.

### BACKGROUND OF THE INVENTION

The present invention relates to recycled products and, more particularly, to a method of recycling expanded polystyrene foam into flexible insulation elements that are made from 100% recycled material.

Recycling reduces mining and drilling, two activities that are the chief culprits in producing air and water pollution. Manufacturing with recycled materials saves energy and water, but it also results in less air and water pollution than manufacturing with raw materials.

In particular, expanded polystyrene foam (EPS), colloquially known in North America as “styrofoam”, is a product that has plagued our planet's landfills. Over two million tons of EPS ends up in landfills, accounting for about 30% of landfill space worldwide. EPS does not readily biodegrade and it has been estimated that it takes at least 500 years for plastic foam to break down—or longer, as some reports indicate it may take 500,000 years to 1,000,000 years for EPS to safely biodegrade. Additionally, EPS lets off toxic fumes when exposed to heat, typically 375 degrees to 500 degrees Fahrenheit, and it is also a very flammable material with an ignition point of approximately 680 degrees Fahrenheit.

Current methods of EPS recycling are limited in shape and form, typically taking the form of rigid blocks.

As can be seen, there is a need for a method of recycling expanded polystyrene foam (EPS) that results in flexible, shapeable elements for expanding the applicability of such recycled products, particularly for different applications in insulation. The present invention embodies flexible insulation elements that are made from 100% recycled material, including recycled EPS. The flexible insulation elements embody recycled EPS, plastic, paper and aluminum so as to be used for insulation in construction, as well as other applications. Being composed of flammable EPS, the flexible insulation elements should incorporate some form of fire retardancy to allow more time to extinguish flames; thereby the flexible insulation elements may include an exterior coating of a fire-retardant clear coat.

### SUMMARY OF THE INVENTION

In one aspect of the present invention, a method of manufacturing a flexible insulation element from recycled expanded polystyrene foam includes the following: providing a wrapper having two opposing longitudinal edges, a top edge and a bottom edge; providing a sheet of recycled paper; lining the sheet of recycled paper with a sheet of recycled plastic; and trimming said sheets so that said sheets are generally coextensive with each other; forming the wrapper into a tubular element by sealing the two opposing longitudinal edges so that the sheet of recycled paper is outward facing; filling a lumen of the tubular element with a grounded expanded polystyrene foam; sealing the top and bottom edges; and heat-pressing an exterior of the tubular element so as to laminate said sheets and compact the grounded expanded polystyrene foam, wherein certain embodiments, prior to trimming said sheets, lining a sheet of radiant aluminum foil on the sheet of recycled plastic on a side thereof that is opposite the sheet of recycled paper.

In another aspect of the present invention, a flexible tubular insulation element made from recycled material includes the following: a tubular element having a laminated wrapper comprising: an outward-facing sheet of recycled paper; a sheet of radiant aluminum foil defining a lumen of the tubular element; and a sheet of recycled plastic disposed between the sheets of recycled paper and radiant aluminum foil; and the lumen filled with compacted expanded polystyrene foam.

These and other features, aspects and advantages of the present invention will become better understood with reference to the following drawings, description and claims, along with further development.

### BRIEF DESCRIPTION OF THE DRAWINGS

FIG. 1 is an exploded perspective view of an exemplary embodiment of the present invention, shown in use;

FIG. 2 is a perspective view of an exemplary embodiment of the present invention, illustrating the layers of a wrapper;

FIG. 3 is a perspective view of an exemplary embodiment of the wrapper of the present invention, illustrated in a folded, flat condition;

FIG. 4 is a perspective view of an exemplary embodiment of the present invention, illustrating the folding of the layers of the wrapper 10 in a tubular element;

FIG. 5 is a perspective view of an exemplary embodiment of the present invention, illustrating placement of recycled expanded polystyrene into the tubular element;

FIG. 6 is a section view of an exemplary embodiment of the present invention, taken along line 6-6 of FIG. 1;

FIG. 7 is a detailed section view of an exemplary embodiment of the present invention; and

FIG. 8 is a flow chart of an exemplary process of making the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a method of recycling expanded polystyrene foam into flexible insulation elements that are made from 100% recycled material.

It should be understood by those skilled in the art that the use of directional terms such as upper, lower, upward, downwardly, top, left, right and the like are used in relation to the illustrative embodiments as they are depicted in the figures, the upward direction (or upper) being toward the top of the corresponding figures, downward direction being toward the bottom of the corresponding figures.

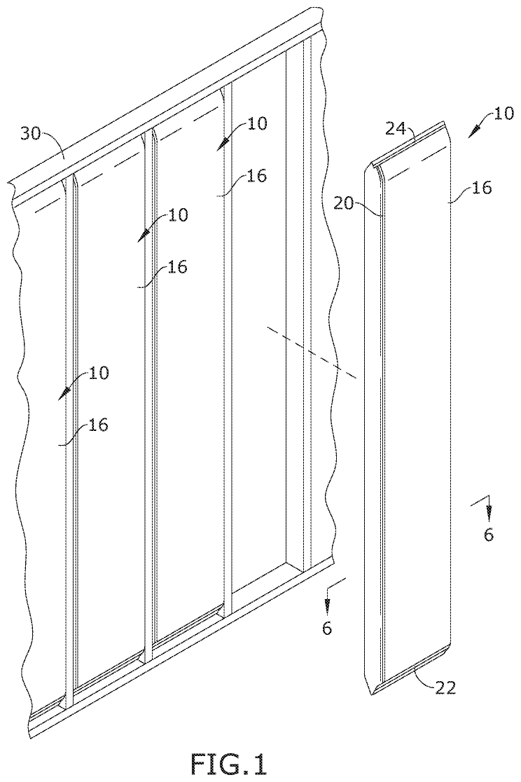

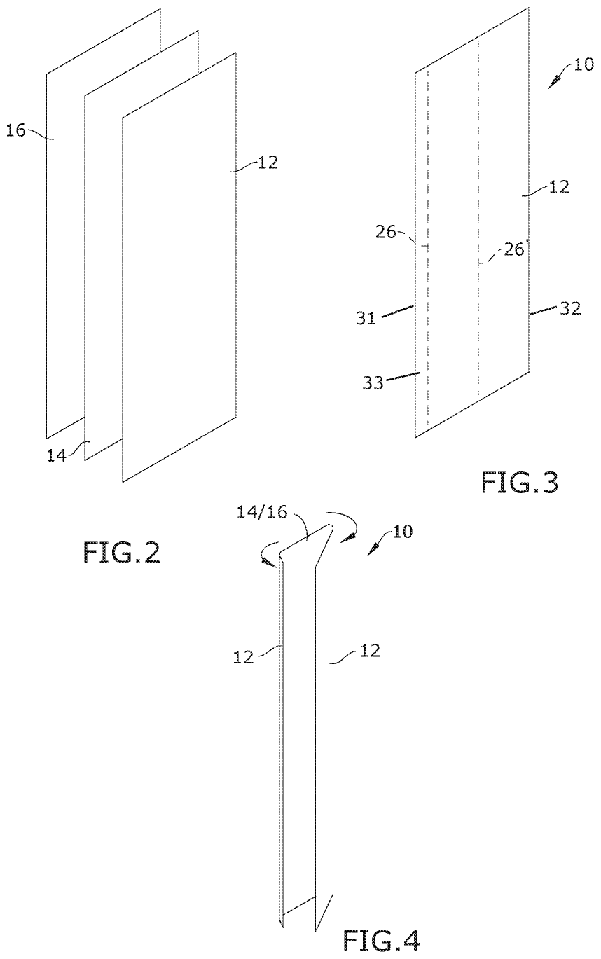

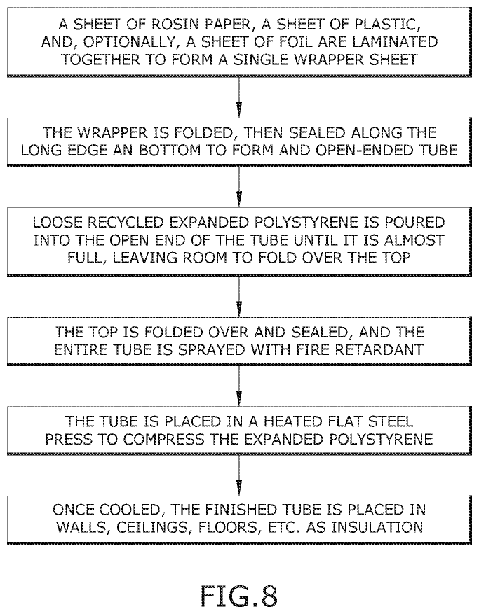

Referring to FIGS. 1 through 8, the present invention may include a method of manufacturing a flexible insulative element from recycled materials, such as recycled expanded polystyrene foam (EPS), recycled paper, recycled plastic, and recycled aluminum, through the following steps.

First, a manufacturer may form a wrapper 10 by laying out a first sheet of recycled paper 12, such as red rosin paper. The recycled paper 12 is a portion of a moisture barrier, as the recycled paper 12 absorbs moisture, slowing moisture from flowing from one side of the first sheet 12 to its opposing side. In one embodiment, the first sheet of 12 may be eight feet and four inches by three feet.

Second, the manufacturer may line the first sheet of recycled paper 12 with a second sheet of recycled plastic 14, providing an additional elemental barrier, as the recycled plastic 14 prevents moisture from flowing or traveling from one side of the second sheet 14 to its other side. The first and second sheet 12 and 14 work together as a moisture barrier, as the first sheet 12 absorbs moisture from getting to the second sheet 14, which prevents the remaining moisture from penetrating any further.

In certain embodiments, a third sheet of radiant aluminum foil 16 may be applied over the second sheet of recycled plastic so that the wrapper 10 provides the second sheet 14 disposed between the first and third sheets 12 and 16, respectively. The recycled radiant aluminum foil (third sheet) 16 allows for even greater insulation. The user may trim the first, second and/or third sheets 12, 14, and/or 16 so that they are all generally coextensive with each other.

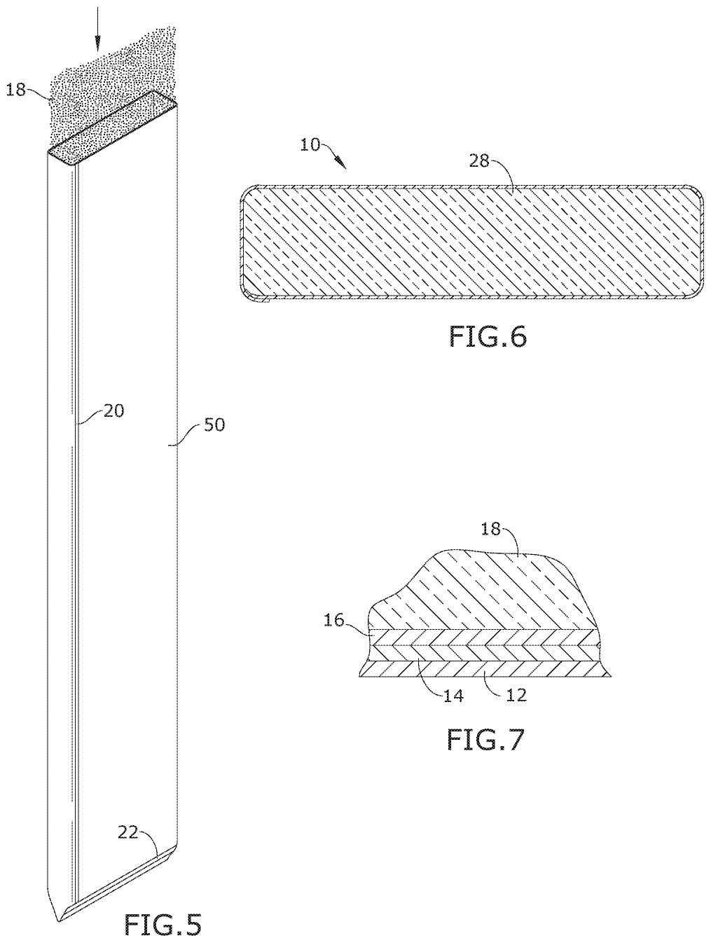

As illustrated in FIG. 4, the manufacturer may make at least two longitudinal fold lines 26, the first fold line 26 should be just inward of a first longitudinal edge 31, defining an edge tab 33. A second fold line 26′ may be disposed approximately halfway between the first fold line 26 and a second longitudinal edge 32. The manufacturer may fold along both the first and second fold lines 26 and 26′ so as to form a tubular element 50, wherein the tubular element is defined by the first sheet 12 being outward-facing closed off by forming a side seal 20 between the edge tab 33 and an adjacent portion of the wrapper 10, as illustrated in FIG. 5. An adhesive may be used to form the side seal 20. Likewise, adhesive may be used to close off the bottom end of the tubular element 50, by way of a bottom seal 22. The adhesive may be glue and/or tape.

The manufacturer may provide loose recycled expanded polystyrene (REP) 18, through breaking down EPS by using a rotary grinder or the like. The manufacture may fill the tubular element 50 through the top end thereof with the loose REP 18, leaving approximately a two-inch space (approximately means one to three inches) to close the top end of the tubular element 50.

Then the manufacturer may close off the top end of the tubular element 50 with adhesive, forming a top seal 24. The manufacturer may spray the tubular element 50 with a fire-retardant spray.

Then the manufacturer may press the tubular element 50 gently with a heated press, or the like, to compress the loose REP 18. The goal is to press the air out of the tubular element 50, pushing the loose REP 18 as close as possible, forming compacted REP 28, while still allowing some flexibility. The heated pressing also laminates the first, second and third sheets 12, 14, and 16 together, thereby forming a unitary wrapper 10. The manufacturer should be sure to not over melt or ignite anything. Once cooled, the flexible insulation element 100 is ready to be used for insulation. The unitary wrapper 10 of the tubular element 50 provides an outward facing moisture barrier of the first and second sheets 12 and 14, adapted to prevent moisture from reach the compacted REP 28. The second sheet of recycled plastic 14 also prevents oxidation of the third sheet of radiant aluminum foil 16 and the compacted REP 28.

The flexible insulation element 100 works the same way as Styrofoam™ (a trademarked brand of The Dow Chemical Company composed of closed-cell extruded polystyrene foam (XPS)) insulation. Yet the flexible insulation element 100 embodied by the present invention is thicker, more cost efficient, and provides a means for cleaning the planet.

The flexible insulation element 100 may be dimensioned and adapted to be the same width as the space in between adjacent wall studs 30 of a house or building. The flexible insulation element 100 may be put it in the roof, inside a cooler, space craft, aircraft, boats, refrigerators, or anything that needs to be insulated.

It should be understood, of course, that the foregoing relates to exemplary embodiments of the invention and that modifications may be made without departing from the spirit and scope of the invention as set forth in the following claims.

What is claimed is:

1. A method of manufacturing a flexible insulation element from recycled expanded polystyrene foam, comprising:
providing a wrapper having two opposing longitudinal edges, a top edge and a bottom edge, comprising:
providing a sheet of recycled paper;
lining the sheet of recycled paper with a sheet of recycled plastic; and
trimming said sheets so that said sheets are generally coextensive with each other;
forming the wrapper into a tubular element by sealing the two opposing longitudinal edges so that the sheet of recycled paper is outward facing;
filling a lumen of the tubular element with a grounded expanded polystyrene foam;
sealing the top and bottom edges; and
heat-pressing an exterior of the tubular element so as to laminate said sheets and compact the grounded expanded polystyrene foam.

2. The method of claim 1, further including: prior to trimming said sheets, lining a sheet of radiant aluminum foil on the sheet of recycled plastic on a side thereof that is opposite the sheet of recycled paper.

3. A flexible tubular insulation element made from recycled material, comprising:
a tubular element having a laminated wrapper comprising:
an outward-facing sheet of recycled paper;
a sheet of radiant aluminum foil defining a lumen of the tubular element; and
a sheet of recycled plastic disposed between the sheets of recycled paper and radiant aluminum foil; and
the lumen filled with compacted expanded polystyrene foam.
